(19) United States
(12) Patent Application Publication
(10) Pub. No.: US 2026/0298308 A1
(43) Pub. Date: Oct. 1, 2026

(54) RESONANCE REDUCING HOUSING FOR VIBRATION SENSOR ASSEMBLY

(71) Applicant: Blue Oak Co., Ltd., Bangkok (TH)

(72) Inventors: Pattana Lee, Bangkok (TH); Kunanon Kittipute, Bangkok (TH); Somboon Chiewcharnpipat, Bangkok (TH); Waranont Anukool, Chiang Mai (TH)

(73) Assignee: Blue Oak Co., Ltd., Bangkok (TH)

(21) Appl. No.: 19/574,591

(22) Filed: Mar. 23, 2026

Related U.S. Application Data
(60) Provisional application No. 63/777,721, filed on Mar. 26, 2025.

(51) Int. Cl. F16F 15/02

(52) U.S. Cl. CPC F16F 15/022; F16F 2228/04; F16F 2230/0047; F16F 2230/02; F16F 2230/10

(57) ABSTRACT

An apparatus includes a vibration sensor and an asymmetric damper. The apparatus includes a resonance reducing housing enclosing the vibration sensor coupled to an asymmetric damper. The inside surfaces of the resonance reducing housing include raised patterns. The vibration sensor is mechanically pressed against a target surface through the damper and the resonance reducing housing, under a spring.

### TECHNICAL FIELD

This disclosure relates generally to devices, systems, and technologies for vibration sensors, and more specifically to housings for reduction of resonance response in vibration sensing assemblies.

### BACKGROUND

Vibration sensors are essential in various applications such as a seismic monitoring, structural health monitoring, and industrial machinery diagnostics. The sensors are designed to detect vibrations and provide accurate measurements for different systems. However, a major challenge arises when external vibrations cause an unwanted resonance in the frequency range of interest, which interferes with the accurate detection of the target vibration signal. This results in distorted or inaccurate measurements or signals buried in noise, which can impact the effectiveness and reliability of the sensors.

Existing vibration sensor systems attempt to address this issue through different methods, but they often face limitations such as complexity, bulkiness, or difficulty in reducing resonance across a wide frequency range or a particular frequency range of interest. These challenges make it difficult to maintain accuracy and compactness needed for effective performance in real-world applications. Therefore, there is a need for a vibration sensor assembly that can effectively reduce resonance over a selected, broad frequency range while maintaining a simple, compact, and efficient design, particularly for vibration sensor-based fall detection systems, where size, sensitivity, and accuracy are crucial.

### SUMMARY

In view of the aforementioned limitations, an object of the present disclosure is to provide a solution that optimizes damping performance and resonance reduction in vibration sensor assemblies through the use of an asymmetric damper and an asymmetric resonance reducing housing. This solution enhances the damping performance and reduces the resonance across a wide frequency range of interest, thereby ensuring accurate and reliable measurements.

According to a first aspect, an apparatus includes a vibration sensor and an asymmetric damper. The apparatus includes a resonance reducing housing enclosing the vibration sensor and the asymmetric damper. The resonance reducing housing has inside surfaces which include raised patterns. The vibration sensor is mechanically pressed against a target surface through the damper and the resonance reducing housing, under a spring, so that the sensor is under pressure or compressed. Thus, the system enhances damping performance and reduces resonance, thereby improving the accuracy of the vibration sensor and ensuring precise and reliable measurements.

According to the above aspect, the vibration sensor may be a geophone. Thus, the system enhances a detection of sudden impacts or falls by precisely sensing vibrations, ensuring accurate and reliable identification of vibration types.

According to the above aspect, the target surface may be a floor. Thus, the system is optimized for a real-world application where the vibration sensor is used to monitor a structural vibrations, machinery, or human falls, improving practical applicability and overall performance.

According to the above aspect, the raised patterns may extend between approximately 2 mm and approximately 2.5 mm from the inside surfaces. Thus, these raised patterns contribute to effective resonance reduction, ensuring the sensor's ability to reduce unwanted vibrations and interference, leading to more accurate and reliable readings and a higher signal to noise ratio.

According to the above aspect, the asymmetric damper may include at least two protuberances extending from a portion enclosing the vibration sensor, with each protuberance holding and affixed to a mass. Thus, the asymmetrical configuration of the damper improves the damping effect, optimizing a resonance reduction across a broad frequency range of interest for precise sensor readings.

According to the above aspect, the protuberances and the portion enclosing the vibration sensor may be manufactured via a process selected from 3D printing, injection molding, and thermoforming as a single piece. The manufacturing of these components as a single unit simplifies manufacturing and assembly, reducing complexity while ensuring structural integrity and reducing the overall system's size.

According to the above aspect, the asymmetric damper includes a top piece mechanically attached to a sensor holding piece via the spring. The sensor is affixed to the sensor holding piece. The top piece is mechanically attached to the portion enclosing the sensor. The top piece, the sensor holding piece, the protuberances, and the portion enclosing the vibration sensor are all manufactured via a process selected from 3D printing, injection molding, and thermoforming. Thus, this configuration may streamline the assembly process, reduces manufacturing complexity, and enhances structural integrity of the system by integrating multiple components into a single structure.

According to the above aspect, the top piece, the sensor holding piece, the asymmetric protuberances, and the portion holding the vibration sensor may be manufactured via a process selected from 3D printing, injection molding, and thermoforming from a material selected from plastic and composite. The manufacturing process and material are selected to optimize manufacturing according to the particular embodiment. For example, in some embodiments, the use of 3D printing with plastic filament further simplifies manufacturing, reduces material waste, and allows for a more precise and customizable component designs, leading to a more efficient and cost-effective production process. In other embodiments, injection molding or thermoforming may be more efficient and cost-effective.

According to a second aspect, a damper assembly includes at least one portion enclosing a vibration sensor and having a hole for allowing a vibration sensor to pass through to a target surface, at least two protuberances, and a spring. The portion encloses the vibration sensor within the hole. The protuberances are asymmetrically arranged, extending from the portion enclosing the vibration sensor, with each protuberance holding and affixed to a mass. The portion enclosing the vibration sensor and the protuberances form a single piece. The spring is permanently attached between a cover and a sensor holding piece within the portion enclosing the vibration sensor. The sensor holding piece is permanently attached to a first end of the spring, and an opposite side of the sensor holding piece is permanently attached to a base of the vibration sensor. The cover is mechanically attached to the portion enclosing the vibration sensor, thereby holding the vibration sensor against the target surface while being attached to the portion. Thus, this configuration simplifies the assembly, optimizes resonance reduction, and ensures the sensor is securely placed against the target surface for accurate measurements.

According to a third aspect, a housing for a vibration sensor includes a top side, a bottom side, and at least two inside surfaces. The bottom side includes a hole through which the vibration sensor is compressed, or pressed, against a target surface. The two inside surfaces of opposite sides of the housing have raised patterns. Thus, the housing design further contributes to a resonance reduction, ensuring more effective vibration sensing across a frequency range of interest.

According to a fourth aspect, an apparatus includes a means for sensing vibration, a first means for reducing resonance and frequency shifting, and a means for housing. The first means for reducing resonance and frequency shifting shifts resonance outside of a frequency range of concern between approximately 0 Hz and approximately 100 Hz. The first means for reducing resonance and frequency shifting is mechanically coupled to the means for sensing vibration. The means for housing includes a second means for reducing resonance and frequency shifting, which shifts the resonance outside of a second frequency range of concern between approximately 0 Hz and approximately 300 Hz. The means for housing is mechanically coupled to the first means for reducing resonance and frequency shifting. Thus, the combination of these features ensures effective vibration sensing and resonance reduction across a wide frequency range of concern, improving reliability and accuracy of measurements.

According to a fifth aspect, a damper assembly includes a means for sensing vibration, and a means for reducing resonance and frequency shifting. The means for reducing resonance and frequency shifting shifts a resonance outside of a frequency range of concern between approximately 0 Hz and approximately 100 Hz. The means for reducing resonance and frequency shifting is mechanically coupled to the means for sensing vibration. Thus, the integration of these components provides a compact and efficient solution that ensures accurate vibration sensing by effectively minimizing unwanted resonance within the specified frequency range.

According to a sixth aspect, a housing for a vibration sensor includes a top side, a bottom side, a front side, a back side, and inside surfaces. The bottom side includes a hole through which the vibration sensor is pressed or compressed against a target surface. The inside surfaces of opposite sides of the housing include means for reducing resonance and frequency shifting. The means for reducing resonance and frequency shifting shifts resonance outside a frequency range of concern between approximately 0 Hz and approximately 300 Hz. Thus, the housing design contributes to resonance reduction, improving accuracy and reliability of the vibration sensor across a specified range of frequencies.

According to the present disclosure, it is possible to improve damping efficiency and minimize resonance in vibration sensor assemblies, ensuring precise measurements and enhanced performance of vibration sensor-based fall detection systems over a frequency range of concern.

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Further aspects and advantages of the present invention will become apparent upon reading the following detailed description in conjunction with the accompanying drawings, in which:

FIG. 1 is a three-dimensional perspective view of a damper assembly, in accordance with a first embodiment of the present disclosure.

FIGS. 2A and 2B show three-dimensional side perspective views of the damper assembly, in accordance with the first embodiment of the present disclosure.

FIG. 3 is a three-dimensional perspective drawing showing a cut-away view of the damper assembly, in accordance with the first embodiment of the present disclosure.

FIG. 4 shows a top view of a main piece of the damper assembly, in accordance with the first embodiment of the present disclosure.

FIG. 5 shows a bottom view of the damper assembly, in accordance with the first embodiment of the present disclosure.

FIG. 6 shows a perspective view of bolting pieces of the damper assembly, in accordance with the first embodiment of the present disclosure.

FIG. 7 illustrates a perspective view of a top piece of the damper assembly, in accordance with the first embodiment of the present disclosure.

FIG. 8 illustrates an exploded and cut away view of the damper assembly, in accordance with another embodiment of the present disclosure.

FIG. 9 illustrates a graph depicting the resonance response of a damper assembly with and without the use of an asymmetric damper, in accordance with an exemplary embodiment of the present disclosure.

FIGS. 10A through 10E show perspective views of an inside of a housing, in accordance with an embodiment of the present disclosure.

FIG. 11 shows a perspective view of the exterior of the housing, in accordance with an embodiment of the present disclosure.

FIG. 12 is a graph showing resonance response, with and without raised patterns on the housing, in accordance with an exemplary embodiment of the present disclosure.

FIGS. 13A and 13B show perspective views of a damper assembly in accordance with another embodiment of the present disclosure.

FIG. 14 shows a line drawing of the vibration sensor in use in a residential setting, in accordance with an exemplary embodiment of the present disclosure.

While the disclosure is amenable to various modifications and alternative forms, specifics thereof have been shown by way of examples in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DETAILED DESCRIPTION

Embodiments of the present invention will now be described with reference to the drawings. In the present specification and the figures, elements like those described above with respect to the previous figures may be denoted by the same reference numerals, and detailed descriptions may be omitted accordingly.

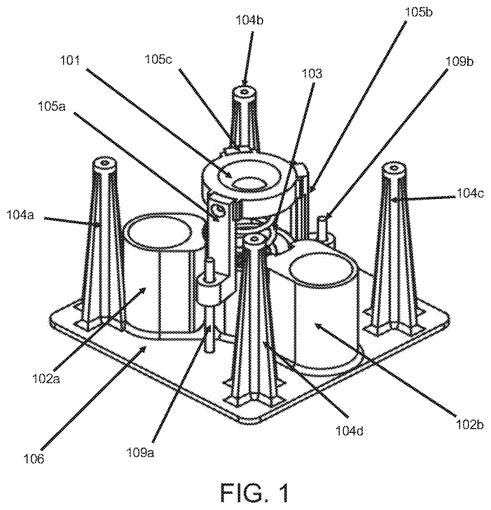

Referring to FIG. 1, a three-dimensional perspective view of a damper assembly is shown in accordance with a first embodiment of the present disclosure. A damper assembly (100) includes an asymmetric damper having a base plate (106), protuberances (102a, 102b), a top piece (101) (hereinafter also referred to as a “cover”), a spring (103), bolting pieces (105a, 105b, 105c), screws (109a, 109b), and bosses (104a, 104b, 104c, and 104d). In one embodiment, the bosses (104a, 104b, 104c, and 104d) are arranged around outer edges of the base plate (106), holding an electronic circuit board. The electronic circuit board may be aligned with the bosses (104a, 104b, 104c, and 104d) of the base plate (106) and secured with screws on all four bosses (104a, 104b, 104c, and 104d).

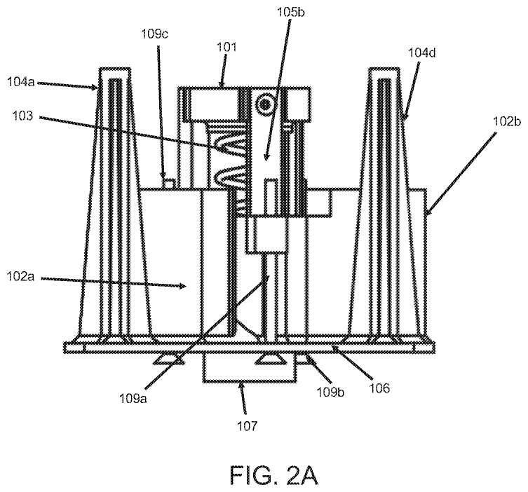

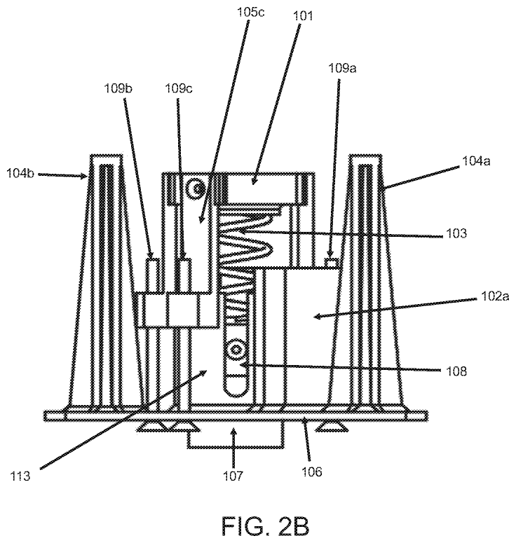

FIG. 2 illustrates a three-dimensional side perspective view of the damper assembly in accordance with the first embodiment of the present disclosure. The damper assembly (100) includes a vibration sensor (107), as shown in FIG. 2A. The vibration sensor (107) detects mechanical vibrations in the target surface and converts them into an electrical signal for accurate monitoring. In some embodiments, the vibration sensor (107) may be a geophone. In others, the vibration sensor (107) may be an accelerometer, an infrasound sensor, or the like. The vibration sensor (107) is mechanically coupled to the asymmetric damper.

As shown in FIG. 2B, the vibration sensor (107) is affixed to a sensor holding piece (108). The sensor holding piece (108) is mechanically attached to the baseplate (106) or portion (113). The vibration sensor (107) is enclosed in a portion (113) that surrounds the vibration sensor (107). The baseplate (106), the protuberances (102a, 102b), and the portion (113) may form a single piece. The top piece (101) of the damper assembly (100) is attached to the sensor holding piece (108) via the spring (103), by glue or other permanent attachement means. The bolting pieces (105a, 105b, 105c) mechanically attach the top piece (101), the spring (103), the sensor holding piece (108), and the vibration sensor (107) to the baseplate (106) or portion (113) using screws (109a, 109b, 109c). The screws (109a, 109b, 109c) may be adjusted to adjust the compression of the vibration sensor (107) by adjusting the pressure against the target surface. The top piece (101), the sensor holding piece (108), the bolting pieces (105a, 105b, 105c), the baseplate (106), the protuberances (102a, 102b), and the portion enclosing the vibration sensor (113) may all be manufactured via a process selected from 3D printing, injection molding, and thermoforming from a material selected from plastic and composite. In some embodiments, 3D printing may be done using plastic filament or filament from composites.

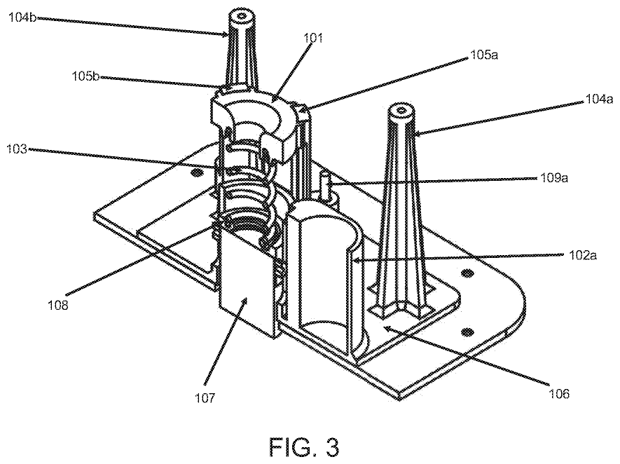

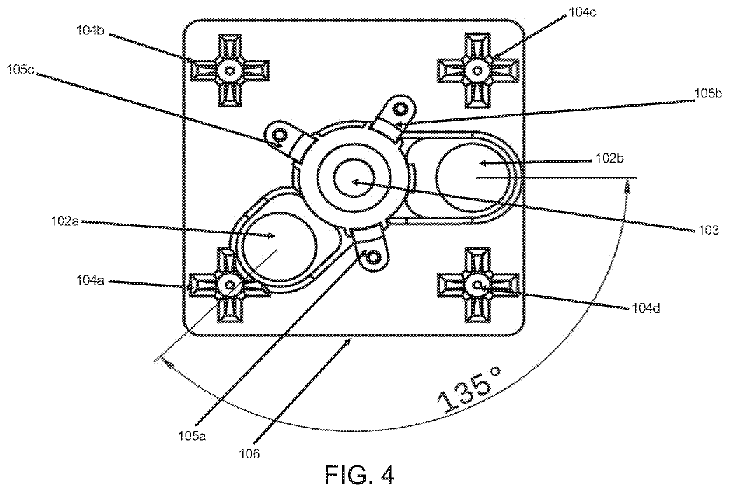

FIG. 3 presents a three-dimensional perspective drawing with a cut-away view of the damper assembly (100) in accordance with the first embodiment. The sectional or cutaway view provides a cross-section of the damper assembly (100). Referring to FIG. 4, a top view of a main piece of the damper assembly (100) is illustrated. The two protuberances (102a, 102b) are arranged asymmetrically, extending from the portion that encloses the vibration sensor. The two protuberances may form an angle of approximately 135.16 degrees relative to each other, as shown. In some embodiments, the angle between the two protuberances may be approximately 135 degrees. Other angles may be possible in other embodiments; however, the two protuberances (102a, 102b) should not be symmetrically arranged 180 degrees from each other.

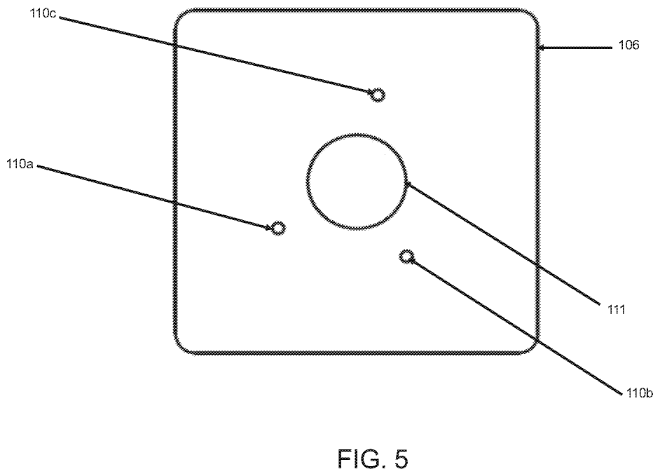

FIG. 5 shows a bottom view of the damper assembly (100). The baseplate (106) has a hole (111) that allows the vibration sensor to pass through to a target surface (for example, a floor, structural element of a building, part of industrial machinery or similar surface being monitored for vibration). The vibration sensor is enclosed in the sensor holding piece within the hole (111). The holes (110a, 110b, 110c) are for the screws used with the bolting pieces. While three bolting pieces and associated screw holes are shown, in other embodiments more or fewer may be used.

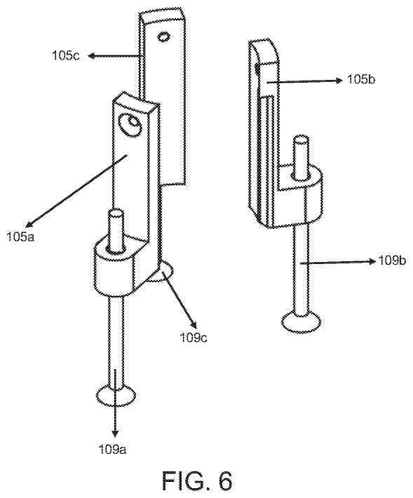

As shown in FIG. 6, the three bolting pieces (105a, 105b, 105c) may be identical. The screws (109a, 109b, 109c) are used in bolting pieces (105a, 105b, 105c) to mechanically attach the top piece, the spring, the sensor holding piece, and the vibration sensor to the baseplate (106). In one exemplary embodiment, the screws may be M3×25 mm screws. Other sizes of screws may be used in other embodiments. The screws (109a, 109b, 109c) are spaced slightly farther apart than the lower edge of the vibration sensor, with this arrangement repeated for all three holes in the baseplate.

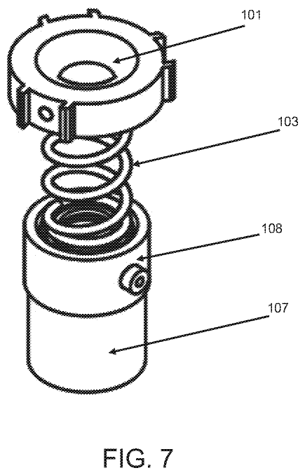

The top piece (101) of the damper assembly (100) is illustrated in FIG. 7. The spring (103) is permanently attached, using glue or the like, between the top piece (101) and the sensor holding piece (108) within the portion enclosing the vibration sensor when the damper assembly (100) is assembled. One side of the sensor holding piece (108) is permanently attached, using glue or the like, to the spring (103), while the opposite side is permanently attached, using glue or the like, to the base of the vibration sensor (107). In some embodiments, the vibration sensor (107) is an accelerometer. In alternate embodiments, the vibration sensor (107) may be an infrasound sensor, a geophone, an accelerometer, or the like.

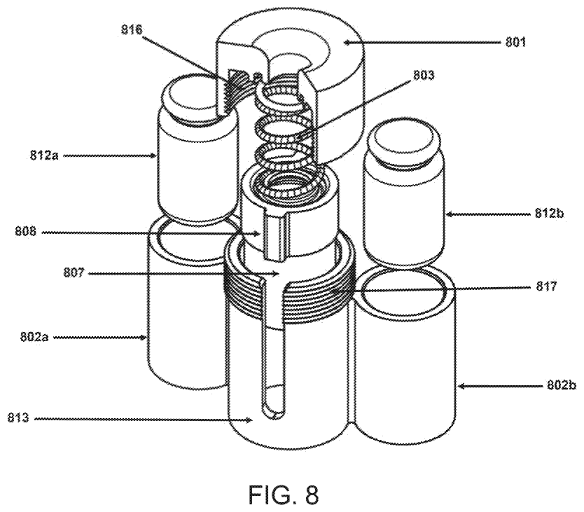

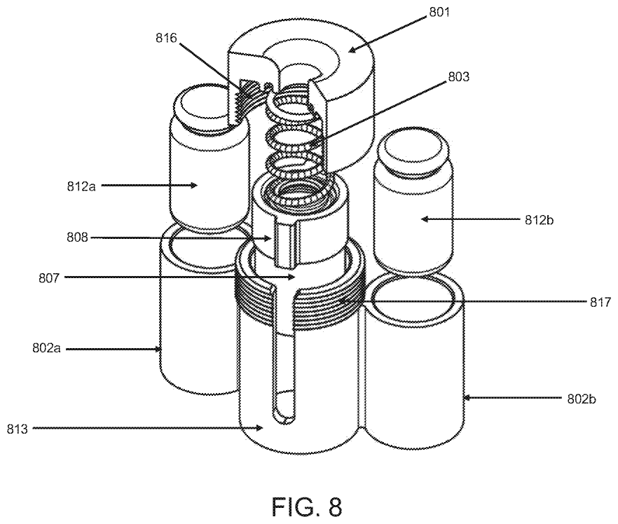

FIG. 8 presents an exploded and cutaway view of the damper assembly, in accordance with another embodiment of the present disclosure having a reduced number of components. The asymmetric damper includes the two protuberances (802a, 802b) extending from the portion (813) enclosing the vibration sensor (807), with each protuberance (802a, 802b) holding and affixed to a mass (812a, 812b) to add weight to the damper. The masses (812a, 812b) are pictured separate from the protuberances (802a, 802b) for ease of viewing in FIG. 8. In a some embodiments, the mass may be a calibrated weight or mass. Each protuberance may hold a mass of at least approximately 100 g. In some exemplary embodiments, each mass (812 a, 812 b) may comprise metal. In other exemplary embodiments, each mass (812a, 812b) may comprise steel. In a preferred embodiment, the top piece (801) may act as a vibration sensor locking piece to clamp down on the sensor holding piece (808), spring (803) and vibration sensor (807). For example, the top piece (801) may be provided with threads (816) and the portion (813) may be provided with interlocking threads (817) as shown in FIG. 8. When the damper assembly is assembled the installer may adjust the compression force holding the vibration sensor (807) against the target surface by hand. In other embodiments, the compression force may not be adjustable and instead the threads (816) and (817) maybe engineered to provide a predetermined compression. Thus, the vibration sensor (807) is mechanically connected to the asymmetric damper. In some embodiments, the asymmetric damper is manufactured via a process selected from 3D printing, injection molding, and thermoforming from a material selected from plastic and composite. In some embodiments, the vibration sensor (807) is an accelerometer. In alternate embodiments, the vibration sensor (807) may be an infrasound sensor, a geophone, an accelerometer, or the like.

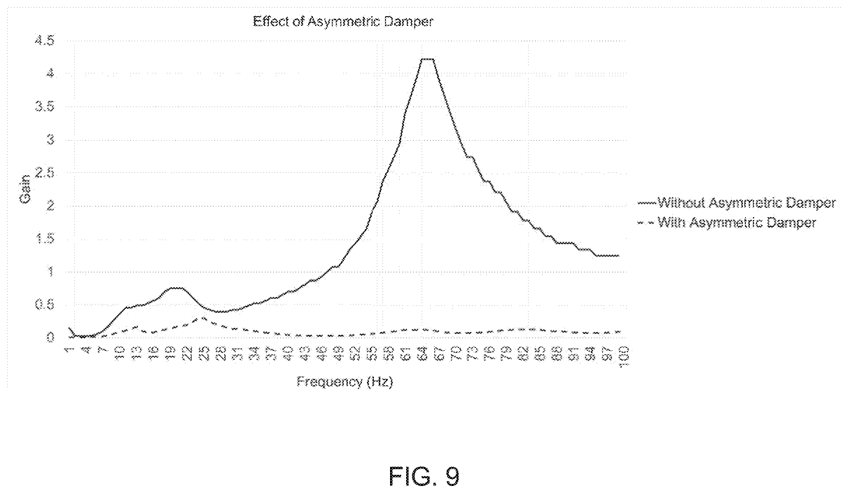

FIG. 9 illustrates a graph showing the resonance response of the vibration sensor assembly both before and after an asymmetric damper was applied. As shown in FIG. 9, the horizontal axis denotes vibration frequency, and the vertical axis denotes gain. The gain-frequency response curve indicates that, with the asymmetric damper, the resonance response is reduced compared to the configuration without the asymmetric damper, thereby improving damping performance, reducing resonance, and enhancing the system's stability. The resonance response is also frequency shifted to the right, to above approximately 100 Hz. Thus the use of an asymmetric damper coupled to the vibration sensor, as shown and described with references to FIGS. 1-8 and 13 provides a means for reducing resonance and frequency shifting remaining resonance outside of a frequency range of concern between approximately 0 Hz and approximately 100 Hz. Such means may correspond to an asymmetric damper having at least two protuberances arranged assymetrically around a portion enclosing the vibration sensor as disclosed herein. Resonance reduction and frequency shifting are achieved using the asymmetric damper, which shifts the resonance outside the frequency range of concern, between approximately 0 Hz and approximately 100 Hz.

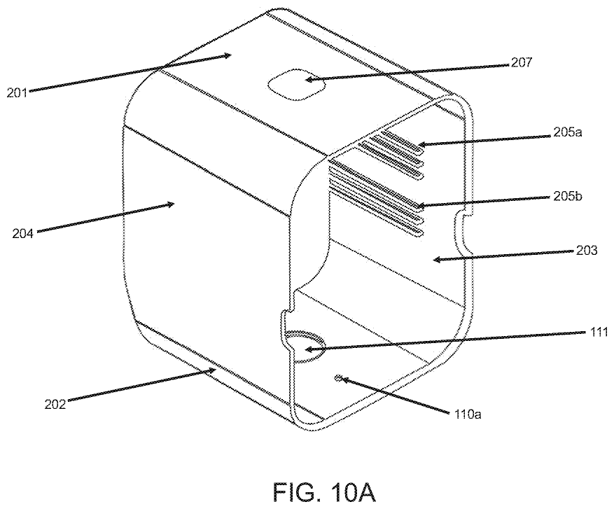

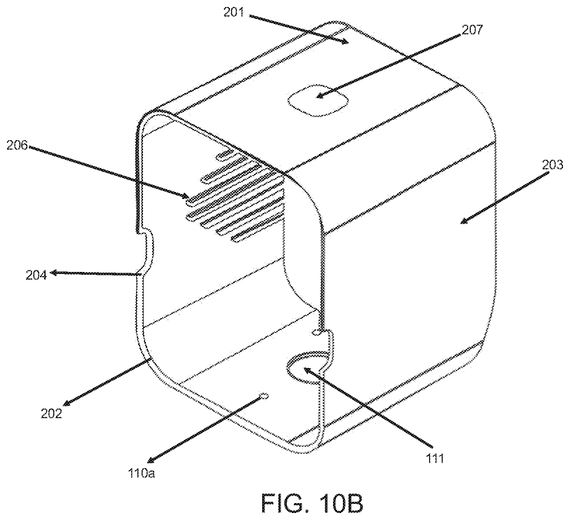

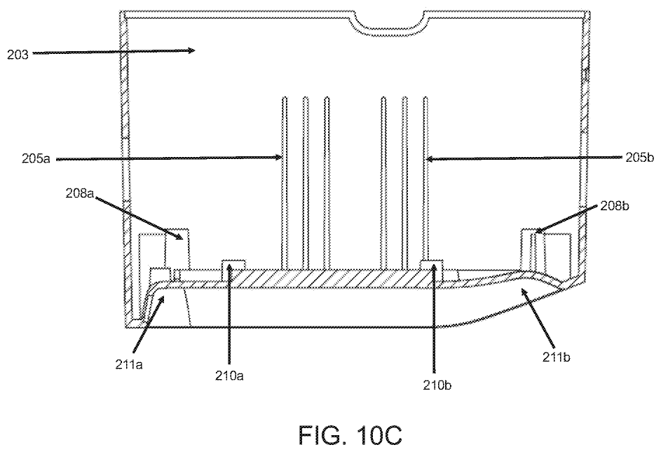

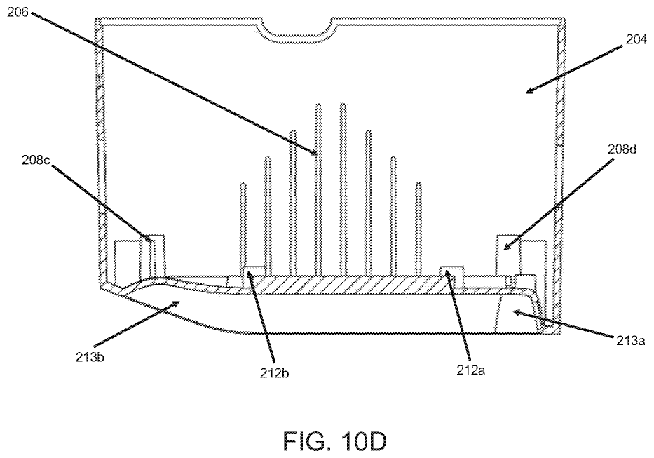

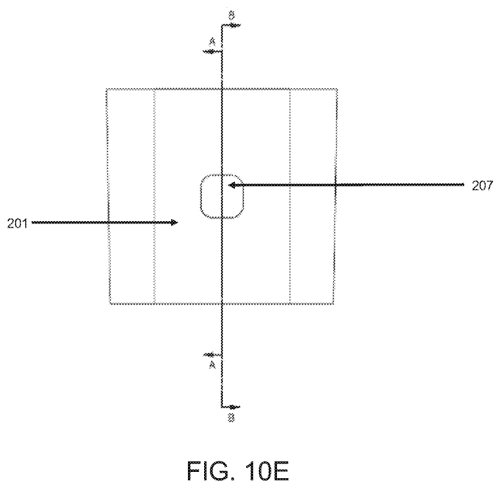

FIG. 10 is perspective views of an inside of a housing in accordance with some embodiments. The housing (200) for the vibration sensor includes a top side (201), a bottom side (202), and two opposite sides (203, 204) as shown in FIG. 10A. In some embodiments, the baseplate (106) of the asymmetric damper may be affixed to the housing (200), which encloses both the sensor and the asymmetric damper. In other embodiments, the bottom of the protuberances and the portion enclosing the vibration sensor may be affixed directly to the housing (200). The inside surfaces of opposite sides (203, 204) of the housing have raised patterns. The top side of the housing (201) includes a hole (207) suitable for a power switch or the like, and the bottom side (202) includes a hole (111). The vibration sensor passes through the hole (111), through which it is compressed, or pressed, against a target surface (for example, floor or other surface being monitored for vibrations). The vibration sensor is mechanically pressed, or compressed, against the target surface through the hole in the portion enclosing the vibration sensor and the bottom side (202) of the housing (200), under a spring.

In some embodiments, the raised patterns have a surface area of at least 15% of the surface area of the corresponding side. In some exemplary embodiments, the raised patterns extend between approximately 2 mm and approximately 2.5 mm from the inside surface. In other exemplary embodiments, the raised patterns extend between approximately 1 mm and approximately 10 mm from the inside surfaces. Preferably, the housing may be injection molded from a plastic material for ease of manufacturing, although other manufacturing methods and materials may be used in other embodiments. Other possible manufacturing methods include thermoforming and 3D printing. Other possible materials include composites.

In some embodiments, the two inside surfaces on opposite sides (203, 204) of the housing (200) have different raised patterns. These raised patterns are designed to reduce resonance and shift the frequency of the resonance response. In some embodiments, the side surface (203) of the housing (200) includes two sets of three equally sized rectangular ribs (205a, 205b). Referring to FIG. 10B, the side surface (204) may include eight rectangular ribs (206), which are arranged in a bell-shaped histogram. The housing (200) is attached to the asymmetric damper to reduce resonance and shift the frequency of the resonance response out of the frequency range of concern.

FIG. 10C shows the set of rectangular ribs (205a, 205b) of the side surface (203), from the perspective of section A-A. The portions (211a, and 211b) are part of the design or external ornamentation, contributing to the overall aesthetic of the housing (200). The parts (210a, 210b) are reinforcement ribs, placed to strengthen the housing and improve its rigidity. The bosses (208a, 208b, 208c, and 208d) may serve as mounts for printed circuit board (PCB) mounting, designed to securely hold a PCB in place according to some embodiments. The wiring of the PCB may be connected to the vibration sensor for sensor control and may be programmed to control other functions of the device. In FIG. 10D, the rectangular ribs (206) of the side surface (204) are shown from the perspective of section B-B. Portions (213a, 213b), which contribute to the housing's design and aesthetics, are also shown. The reinforcement ribs (212a, 212b) enhance the housing's rigidity.

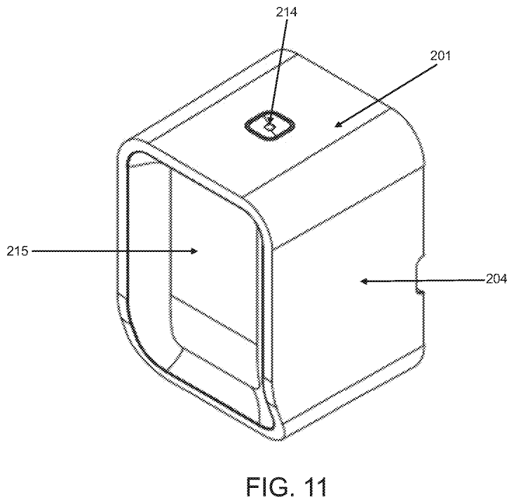

FIG. 10E shows the upper side (201) having a hole (207) designed to accommodate a button, such as a power button, cancel button, alarm cancel button, or the like. In other embodiments, the power button and any other controls may be located elsewhere or the device may be remote controlled. As shown in FIG. 11, which illustrates a perspective view of the housing's exterior, the housing includes an upper side (201) with a button (214) in some embodiments. In one exemplary embodiment, the button (214) may be an alarm cancel button. The front side (215) of the housing (200) includes a light at a corner between the front side (215) and the top side (201) in some embodiments. In an exemplary embodiment, the lighting element is an LED.

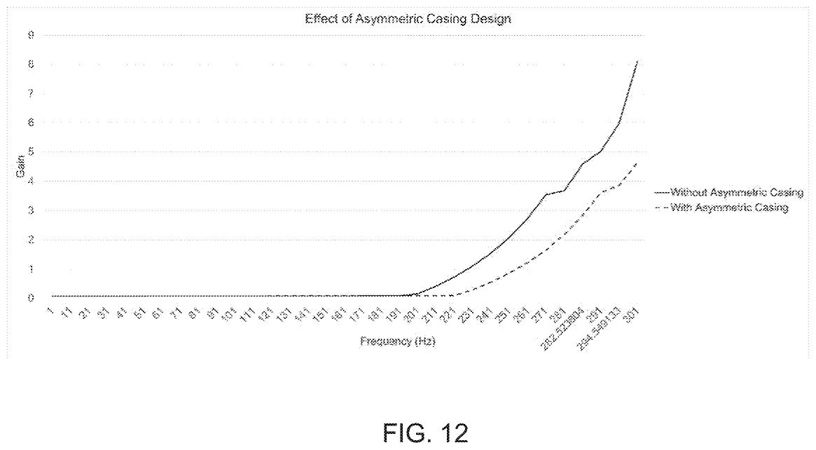

FIG. 12 illustrates a graph showing the resonance response before and after the introduction of raised patterns on the housing, resulting in an asymmetric casing. The graph shows that the resonance response with the raised patterns (asymmetric casing or housing) is lower and frequency shifted to the right compared to the response without the asymmetric casing, indicating that the raised patterns help reduce resonance. Thus the use of raised patterns on the interior of the housing, as shown and described with references to FIGS. 10-11 provides a means for resonance reduction and frequency shifting remaining resonance outside of a second frequency range of concern between approximately 0 Hz and approximately 300 Hz. Such means may correspond to raised patterns on at least two inside surfaces of the housing as disclosed herein. Therefore, the implementation of asymmetric features—such as the asymmetric damper and the asymmetric casing with raised patterns—effectively reduces resonance and shifts resonance from the frequency region of concern.

Raised patterns, in the form of rectangular ribs of the side surfaces of the housing provide resonance reduction and frequency shifting by shifting the resonance outside of a frequency range of concern between approximately 0 Hz and approximately 300 Hz. In an exemplary embodiment, the rectangular ribs of the side surfaces of the housing shifted the resonance frequency of a resonance mode to a frequency above approximately 395 Hz. Thus, raised patterns of different designs on the opposite inside surfaces of the housing reduce vibration and achieve resonance reduction. In some embodiments, the raised patterns may not be in the form of rectangular ribs, but may be in the form of random raised spots, similar to a popcorn ceiling, or any other patterns that disrupt resonance by introducing asymmetry inside the housing.

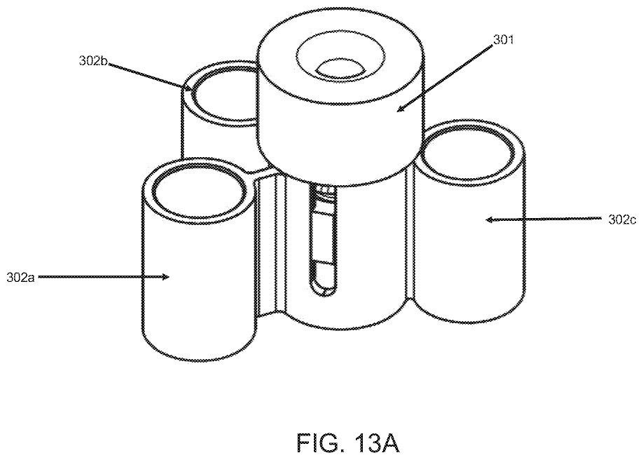

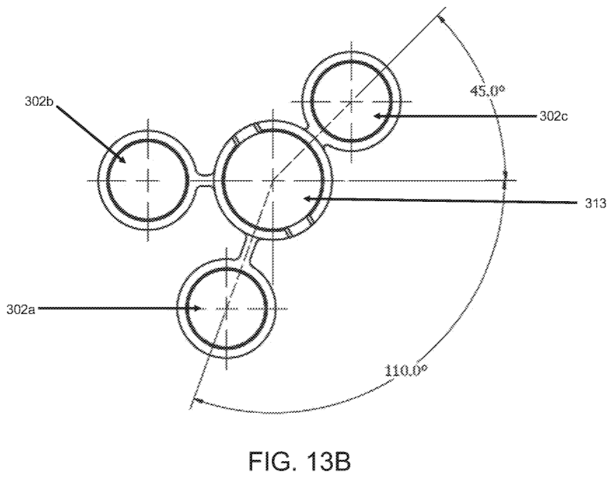

FIG. 13A and FIG. 13B present perspective views of a damper assembly, in accordance with another embodiment of the present disclosure. The damper assembly (300) includes three protuberances (302a, 302b, 302c) as shown in FIG. 13A. The protuberances (302a, 302b, 302c) are arranged asymmetrically around the central portion enclosing the vibration sensor. The protuberances (302a, 302b, 302c) are not equidistantly arranged around the portion enclosing the vibration sensor, and each is at a different angle from the others, as shown in FIG. 13B. In an exemplary embodiment, the protuberance (302 a) may be arranged at a 110-degree angle from a midline extending from the portion enclosing the vibration sensor, as shown. Similarly, the protuberance (302c) may be arranged at a 45-degree angle from the midline extending from the portion holding the sensor (313), as shown. Other asymmetric arrangements of the protuberances (302a, 302b, 302c) are possible in other embodiments. Each protuberance (302a, 302b, 302c) holds and is affixed to a mass. The asymmetric damper includes a vibration sensor, a spring, a top piece (hereinafter also referred to as a “cover”), and a sensor holding piece. Each protuberance (302a, 302b, 302c) holds and is affixed to a mass. Each protuberance may hold a mass of at least approximately 100 g. In some embodiments, each mass may comprise metal. In other exemplary embodiments, each mass may comprise steel. In a preferred embodiment, the top piece (301) may act as a clamp on the vibration sesnsor, and the sensor holding piece may be a hold the vibration sensor.

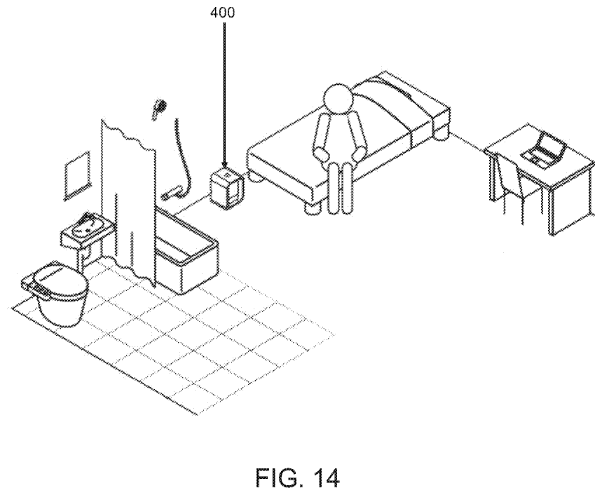

Referring to FIG. 14, the line drawing illustrates a vibration-sensing apparatus in use within a residential setting, according to an exemplary embodiment. The vibration-sensing apparatus (400) is designed to detect falls by monitoring vibrations transmitted through a target surface, such as a floor, and the structure underlying the target surface, such as a building. The omnidirectional vibration sensor allows for flexible placement in various locations, including bedrooms, bathrooms, or other private areas, ensuring effective fall detection while maintaining privacy.

The vibration-sensing apparatus (400) is discreet and integrates seamlessly into the home environment, providing reliable fall detection without compromising privacy. The sensor's high sensitivity to subtle vibrational changes, along with the housing's raised internal patterns and the asymmetrical damper, reduces resonance response and minimizes signal interference. This configuration ensures precise detection of fall-induced vibrations, distinguishing between actual fall events and irrelevant disturbances, making it ideal for environments where both safety and privacy are critical. In some embodiments, the vibration-sensing apparatus may detect human falls with a high accuracy by sensing the unique vibrational patterns associated with such events.

As described above, according to the above embodiments of the present disclosure, the apparatus includes a vibration sensor and an asymmetric damper. The asymmetric damper includes a housing enclosing the vibration sensor and the asymmetric damper. Inside surfaces of the housing include raised patterns. The vibration sensor, through the damper and the housing, under a spring, is mechanically compressed, or pressed, against a target surface. Thus, the system provides an enhanced damper with resonance reduction and frequency shifting, thereby improving the accuracy of vibration sensing and ensuring precise and reliable measurements.

Furthermore, among the processes described in the above embodiments, all or part of the processes described as being automatically performed can be manually performed, or all or part of the processes described as manually performed can be automatically performed using known methods. Additionally, the processing procedures, specific names, and information, including various data and parameters shown in the above documents and drawings, may be arbitrarily modified except as otherwise noted. For example, the various information shown in the figures is not limited to the specific information illustrated.

Furthermore, the components of the illustrated apparatus are functional concepts and are not necessarily required to be physically configured as shown. That is, the specific arrangement, distribution, and integration of the apparatus are not limited to that shown in the figures. The entire apparatus or parts thereof may be functionally or physically distributed and integrated into arbitrary units based on usage conditions, operational considerations, or other factors. Thus, various modifications to the physical structure and integration of the apparatus may be made without departing from the scope of the invention.

Moreover, the present invention is not limited to the above embodiments, and various modifications can be made within the scope of the claims. For example, the technical scope of the present invention includes configurations obtained by appropriately combining the above-described embodiments, provided that the modifications do not conflict with each other. Additionally, the arrangement of the components described in the above embodiments can be modified as necessary, while still achieving the desired functionality and performance as outlined in the invention.

### Terminology

Further, it is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages that may be taught or suggested herein.

Processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

It is to be understood that the electronic circuit control board used in the present invention is not limited to any specific type or configuration. While a printed circuit board (PCB) is described as one exemplary embodiment, the control board may alternatively be realized in various forms, including flexible printed circuits, hybrid circuits, integrated circuit assemblies, or other electronic substrates, as would be understood by those skilled in the art. The configuration and material of the control board will be chosen to meet the operational requirements of the system, and various alternatives may be employed without departing from the scope of the present invention.

The material from which the electronic circuit control board is constructed is not limited to any specific type. The control board may be fabricated from a variety of materials, including but not limited to fiberglass composites, epoxy-resin-based materials, ceramics, or metallic substrates. The material choice for the control board will be based on factors such as electrical conductivity, thermal dissipation, mechanical robustness, and environmental resistance. The scope of the invention includes all modifications to the material composition of the control board that are suitable for the intended application and performance requirements.

Many other variations than those described herein will be apparent from this disclosure. For example, depending on the embodiment, different tasks or processes can be performed by different machines and/or computing systems that can function together.

Methods described in connection with the embodiments disclosed herein can be implemented or performed by a machine, such as a processor. A processor can be a microprocessor, but in the alternative, the processor can be a controller, microcontroller, or state machine, combination of the same, or the like. A processor can include electrical circuitry configured to process computer-executable instructions. In another embodiment, a processor includes an application-specific integrated circuit (ASIC), a field-programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components.

It is to be understood that the vibration sensor utilized in the present invention is not limited to any specific type or configuration and may correspond to any means for sensing vibration. While various sensors may be employed within the scope of the present disclosure, including accelerometers, infrasound sensors, piezoelectric sensors, or other suitable devices for detecting vibrations, accelerations, or other physical phenomena, the particular type of sensor can vary depending on the specific application. It is also understood that different sensor configurations, sensitivities, and ranges can be employed without departing from the scope of the invention. Thus, the sensor type and configuration may be adapted according to the needs of the system as understood by those skilled in the art.

It should be understood that the material from which the damper and other components described herein are constructed is not limited to any particular type. The damper and other components may be fabricated from any material that meets the operational requirements, including metals, plastics, composites, or elastomers, and the like. Materials are selected based on the required characteristics, including damping characteristics, durability, and resistance to environmental factors. Therefore, the choice of material for the damper assembly and/or components thereof may be varied and optimized for the particular application at hand. Such modifications to the material composition can be made within the scope of the present invention, as would be understood by those skilled in the art.

It is to be understood that the masses utilized in the damper assembly, which are affixed to the protuberances, are not limited to any particular form or material. For example, while pendulum-type masses are described as one potential configuration, other types of masses, such as solid or fluid-filled masses, can also be employed to achieve the desired damping effect. In terms of materials, the masses may be fabricated from various materials such as metals (e.g., steel, aluminum), composites, ceramics, or other suitable materials with appropriate density and mechanical properties. The selection of mass type and material will be made in accordance with the application requirements and operational conditions, and modifications may be made within the scope of the present invention.

It is to be understood that the material used for manufacturing the damper and damper components is not limited to any particular type or formulation, and may comprise non-plastics in some embodiments. The filament for 3D printing, for example, may be selected from a variety of thermoplastic materials based on the specific requirements of the application, including but not limited to, polylactic acid (PLA), acrylonitrile butadiene styrene (ABS), polycarbonate (PC), or any other suitable thermoplastic or composite material capable of being processed via 3D printing technologies. A similar variety of thermoplastic materials are available for manufacturing using injection molding or thermoforming, based on the requirements of those manufacturing processes, respectively. The choice of material for 3D printing, injection molding and/or thermoforming will depend on factors such as strength, flexibility, temperature resistance, and other performance characteristics as determined by those skilled in the art, and may vary depending on the specific implementation of the invention. Various modifications to the composition and properties of the material may be made within the scope of the present disclosure.

It is to be understood that the lighting element utilized in the present invention is not limited to any specific type or configuration. While various types of lighting elements, such as LEDs, OLEDs, incandescent bulbs, or other suitable light-emitting devices, may be employed within the scope of the present disclosure, the particular type of lighting element can vary depending on the specific application. It is also understood that different lighting configurations, intensities, and color temperatures can be utilized without departing from the scope of the invention. Thus, the lighting element type and configuration may be adapted according to the needs of the system, as understood by those skilled in the art.

Any type of button can be used in the present invention, as the design and functionality are adaptable to a wide range of button types and configurations. Whether employing mechanical, capacitive, or touch-sensitive buttons, the system can be tailored to fit the specific needs of the application. The choice of button type does not limit the broader functionality of the invention, as it can be adjusted according to the requirements of the user or the system design, as understood by those skilled in the art.

The term “floor” can be interchanged with the term “ground.” Additionally, the term “floor” is intended to refer to any horizontal surface or supporting plane within the context of the invention, and can be understood as being synonymous with other terms such as “surface,” “base,” “platform,” or “foundation” depending on the application. Likewise, the term “ground” can refer to any surface or base upon which an apparatus or system is positioned, whether it is earth, a constructed surface, or any other suitable foundational material. These terms should be interpreted in their broadest sense to encompass any relevant surface that supports the operation of the system, device, or method described herein.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, and elements described herein and/or depicted in the attached figures should be understood as potentially representing modules, segments, or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. For example, “a filament” can include one or more types of filament, depending on the context.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having an intermediate structure between the two components discussed.

Numbers preceded by terms such as “approximately,” “about,” and “substantially” as used herein include the recited numbers and also represent an amount close to the stated amount that still performs a desired function or achieves a desired result. For example, the terms “approximately,” “about,” and “substantially” may refer to an amount that is within less than 10% of the stated amount.

It should be emphasized that many variations and modifications may be made to the above-described embodiments, the elements of which are to be understood as being among other acceptable examples. All such modifications and variations are intended to be included herein within the scope of this disclosure and protected by the following claims.

1. An apparatus, comprising:
a vibration sensor, and
a damper affixed to a resonance reducing housing enclosing the sensor and damper, wherein inside surfaces of the resonance reducing housing include raised patterns, and wherein the sensor, through the damper and the resonance reducing housing, under a spring, is mechanically pressed against a target surface.

2. The apparatus of claim 1, wherein the vibration sensor is a geophone.

3. The apparatus of claim 1, wherein the vibration sensor is an accelerometer.

4. The apparatus of claim 1, wherein the vibration sensor is an infrasound sensor.

5. The apparatus of claim 1, wherein the target surface is a floor.

6. The apparatus of claim 1, wherein the raised patterns extend between approximately 1 mm and approximately 10 mm from the inside surfaces.

7. The apparatus of claim 1, wherein the raised patterns extend between approximately 2 mm and approximately 2.5 mm from the inside surfaces.

8. A housing for a vibration sensor, comprising:
a top side;
a bottom side including a hole through which the vibration sensor is pressed against a target surface; and
at least two inside surfaces of opposite sides of the housing having raised patterns.

9. The housing of claim 8, wherein the raised patterns are different.

10. The housing of claim 8, where a front side includes a light at a corner between the front side and the top side.

11. The housing of claim 8, where a first raised pattern on a first inside surface of the housing comprises at least two sets of at least three, equally sized rectangular ribs; and
a second raised pattern on a second, opposite inside surface of the housing comprises a set of at least eight rectangular ribs arranged in a bell-shaped histogram.

12. The housing of claim 8, wherein the raised patterns extend between approximately 2 mm and approximately 2.5 mm from the inside surface.

13. The housing of claim 8, wherein the raised patterns extend between approximately 1 mm and approximately 10 mm from the inside surfaces.

14. The housing of claim 8, wherein the housing is manufactured via a process selected from 3D printing, injection molding, and thermoforming from a material selected from plastic and composite.

15. The housing of claim 8, wherein the raised patterns have a surface area of at least 15% of surface area of a corresponding side.

16. A housing for a vibration sensor, comprising:
a top side;
a bottom side including a hole through which the vibration sensor is pressed against a target surface;
a front side;
a back side; and
inside surfaces of opposite sides of the housing including means for resonance reduction and frequency shifting remaining resonance outside of a frequency range of concern between approximately 0 Hz and approximately 300 Hz.

17. The housing of claim 16, wherein the means for resonance reduction and frequency shifting remaining resonance outside of the frequency range of concern comprises a first raised pattern on a first inside surface of the housing comprising at least two sets of at least three, equally sized rectangular ribs; and
a second raised pattern on a second, opposite inside surface of the housing comprising a set of at least eight rectangular ribs arranged in a bell-shaped histogram.

18. The housing of claim 16, wherein the means for resonance reduction and frequency shifting remaining resonance outside of the frequency range of concern comprises a raised pattern on opposite inside surfaces of the housing comprising a set of at least eight rectangular ribs arranged in a bell-shaped histogram.

19. The housing of claim 16, wherein the means for resonance reduction and frequency shifting remaining resonance outside of the frequency range of concern includes means for shifting a resonant frequency of a resonance mode to a frequency above approximately 395 Hz.

20. The housing of claim 16, wherein the means for resonance reduction and frequency shifting remaining resonance outside of the frequency range of concern has a surface area of at least 15% of surface area of a corresponding side.
